(19) United States
(12) Patent Application Publication
(10) Pub. No.: US 2005/0198022 A1
(43) Pub. Date: Sep. 8, 2005

(54) Apparatus and method using proxy objects for application resource management in a communication network

(75) Inventor: Wen-Yang Chang, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/864,191

(22) Filed: Jun. 9, 2004

Related U.S. Application Data
(60) Provisional application No. 60/542,105, filed on Feb. 5, 2004.

(51) Int. Cl. G06F 17/30

(52) U.S. Cl. 707/4

(57) ABSTRACT

A telecommunication device comprises a main processing unit for executing client applications and N call application nodes (CANs) for executing server applications. A first primary server application is executed on a first CAN. The first primary server application uses a first proxy object to communicate with members of a first mapped resource group. Each member of the first mapped resource group provides services in response to requests from client applications. The first primary server application is associated with a similar second primary server application executed on a second CAN separate from the first CAN. The second primary server application uses a second proxy object to communicate with the first mapped resource group.

### CROSS-REFERENCE TO RELATED APPLICATION AND CLAIM OF PRIORITY

The present invention is related to that disclosed in U.S. Provisional Patent Application Ser. No. 60/542,105, filed May 5, 2004, entitled “Use of Proxy Objects for Application Resource Management”. U.S. Provisional Patent Application Ser. No. 60/542,105 is assigned to the assignee of the present application. The subject matter disclosed in U.S. Provisional Patent Application Ser. No. 60/542,105 is hereby incorporated by reference into the present disclosure as if fully set forth herein. The present invention hereby claims priority under 35 U.S.C. §119(e) to U.S. Provisional Patent Application Ser. No. 60/542,105.

### TECHNICAL FIELD OF THE INVENTION

The present invention relates generally to telecommunications systems and, more specifically, to a method of using proxy objects to dynamically manage resources in real-time.

### BACKGROUND OF THE INVENTION

Telecommunication service providers continually try to create new markets and to expand existing markets for telecommunication services and equipment. One important way to accomplish this is to improve the performance of existing network equipment while making the equipment cheaper and more reliable. Doing this allows the service providers to reduce infrastructure and operating costs while maintaining or even increasing the capacity of their existing networks. At the same time, the service providers are attempting to improve the quality of telecommunication services and increase the quantity of services available to the end-user.

A conventional switch or router (or similar telecommunication device) typically contains a large switching fabric controlled by a main processing unit (MPU) that contains a large number of data processors and associated memories, often in the form of ASIC chips. Each of these MPU processors contains a call process client application for controlling the flow of control signals of a single call. Each call process client application in turn communicates with a call process server application that controls the flow of control signals for a large number of calls.

Thus, when a particular event occurs during a phone call (e.g., the call set-up, the invocation of three-way calling, call disconnection, or the like), control signals associated with the event are relayed from the origination station to the call process client application in the switching center. This call processing client application then relays the control signals to the call process server application, which actually performs the call processing service requested by the control signals.

Unfortunately, in large capacity systems, bottlenecks may develop around the call process server applications. Each call process client application must communicate with a particular piece of server hardware that is executing the call process server application. Due to the random nature of the start and stop of phone calls, in large systems, some servers may be near capacity and develop bottlenecks, while other servers still have plenty of adequate bandwidth. Moreover, a system failure in a particular piece of server hardware results in the loss of all call processes being handled by a call process server application being executed on the failed server.

Moreover, upgrading the call process server applications in a conventional switching center without interrupting existing service is extremely complicated. In some prior art systems, performing a software upgrade requires fully redundant (duplex) hardware in the switching center. The redundant components are split into an active side and an inactive side. Complex control software is required to manage the split (by swapping active and inactive sides) and to manage the process of merging the two halves of the system back into a unitary system. The redundant hardware adds excessive cost to the prior art switching center and the complex control software is expensive to develop, susceptible to errors due to its complexity, and difficult to maintain.

Therefore, there is a need for improved telecommunication networks. In particular, there is a need for switches/routers that may easily undergo on-line. More particularly, there is a need for switches that may be upgraded without requiring redundant hardware and without requiring complex and expensive control software.

### SUMMARY OF THE INVENTION

U.S. patent application Ser. No. 10/039,186, filed Dec. 31, 2001, entitled “SYSTEM AND METHOD FOR DISTRIBUTED CALL PROCESSING USING A DISTRIBUTED TRUNK IDLE LIST”, discloses improved switching devices that use mapped resource groups to distribute a variety of call processing tasks across a plurality of call application nodes (CANs) or servers. U.S. patent application Ser. No. 10/039,186 is assigned to the assignee of the present application and is hereby incorporated into the present invention as if fully set forth herein.

The present invention improves upon the devices disclosed in U.S. patent application Ser. No. 10/039,186 by introducing the use of proxy objects to manage application resources in the mapped resource groups.

The mapped resource groups of U.S. patent application Ser. No. 10/039,186 distribute work loads for a number of tasks, including conventional call processing (CP), identity server (IS), subscriber database (SDB), idle list server (ILS) (also called trunk idle list (TIL)). In an exemplary embodiment of the present invention, an idle list server (ILS) mapped resource group (MRG) distributes ILS applications across several call application nodes (CANs). Each idle list server application in a CAN manages a set of the trunk idle lists. Idle list servers may be added or taken away without having to perform any configuration. Proxy objects associated with each ILS application enable the primary member of each idle list server application to communicate within other ILS applications in the mapped resource group (MRG).

To address the above-discussed deficiencies of the prior art, it is a primary object of the present invention to provide a telecommunication device capable of handling call connections between calling devices and called devices. According to an advantageous embodiment, the telecommunication device comprises: 1) a main processing unit capable of executing a plurality of client applications, wherein each of the client applications is associated with one of the call connections; and 2) N call application nodes capable of executing server applications. A first primary server application is executed on a first one of the N call application nodes. The first primary server application comprises a first proxy object that enables the first primary server application to communicate with members of a first mapped resource group, wherein each member of the first mapped resource group provides services in response to requests from ones of the plurality of client applications.

According to one embodiment of the present invention, the first primary server application is associated with a similar second primary server application executed on a second one of the N call application nodes separate from the first call application node, the first and second primary server applications being members of the first mapped resource group.

According to another embodiment of the present invention, the second primary server application comprises a second proxy object that enables the second primary server application to communicate with the first mapped resource group.

According to still another embodiment of the present invention, the first primary server application is associated with a similar first backup server application executed on one of the N call application nodes separate from the first call application node, wherein the first primary server application and the first backup server application form a first primary-backup group in which state information associated with the first primary server application is mirrored to the first backup server application.

According to yet another embodiment of the present invention, the second primary server application is associated with a similar second backup server application executed on one of the N call application nodes separate from the second call application node, wherein the second primary server application and the second backup server application form a second primary-backup group in which state information associated with the second primary server application is mirrored to the second backup server application.

According to a further embodiment of the present invention, each client application sends a call process service request to the first mapped resource group and the first mapped resource group uses a Resource Key value to select one of the first and second primary server applications to service the call process service request.

According to a still further embodiment of the present invention, the first primary server application controls a first group of resources associated with the telecommunication device and the second primary server application controls a second group of resources associated with the telecommunication device.

According to a yet further embodiment of the present invention, the first proxy object is designated as a leader proxy object in the first mapped resource group.

In one embodiment of the present invention, the first proxy object is capable of reallocating at least one resource from the first group of resources to the second group of resources such that the second primary server application controls the at least one reallocated resource.

In another embodiment of the present invention, the first proxy object is capable of determining that a third primary server application has joined the first mapped resource group and, in response to the detection, is capable of reallocating a first resource from the first group of resources to a third group of resources controlled by the third primary server application and is further capable of a second resource from the second group of resources to the third group of resources.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary telecommunication device, which uses mapped resource groups to perform distributed call processing in accordance with the principles of the present invention;

FIG. 2 is a high-level flow diagram illustrating the use of proxy objects to manage application resources in mapped resource groups according to the principles of the present invention;

FIG. 3 illustrates selected portions of an idle list server initialization operation according to an exemplary embodiment of the present invention;

FIG. 4 illustrates selected portions of an idle list server initialization operation according to an exemplary embodiment of the present invention;

FIG. 5 illustrates selected portions of an idle list server initialization operation according to an exemplary embodiment of the present invention; and

FIG. 6 illustrates selected portions of an idle list server initialization operation according to an exemplary embodiment of the present invention.

### DETAILED DESCRIPTION OF THE INVENTION

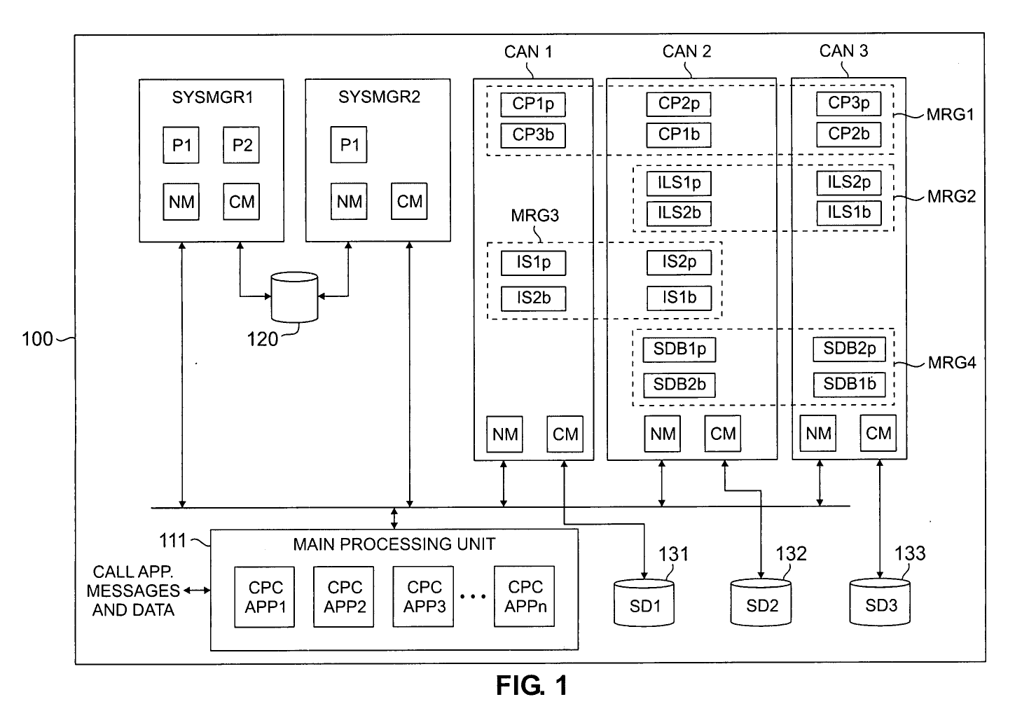

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunication device.

FIG. 1 illustrates exemplary telecommunication device 100, which uses mapped resource groups to perform distributed call processing in accordance with the principles of the present invention. In an exemplary embodiment of the present invention, telecommunication device 100 may be, for example, a switch or a router in a wireline network, such as the public switched telephone network (PSTN). In another exemplary embodiment of the present invention, telecommunication device 100 may be a mobile switching center (MSC) of a wireless network (e.g., cell phone network) that handles call processing for mobile stations that communicate wirelessly with a plurality of base stations of the wireless network.

Telecommunication device 100 comprises main processing unit (MPU) 110, system manager node 1 (SYSMGR1), optional system manager node 2 (SYSMGR2), and master database 120. Telecommunication device 100 also comprises a plurality of call application nodes (CANs), including CAN1, CAN2, and CAN3, and a plurality of local storage devices (SDs), namely SD1, SD2, and SD3, that are associated with CAN1, CAN2 and CAN3. Master database 120 may be used as a master software repository to store databases, software images, server statistics, log-in data, and the like. SD1-SD3 may be used to store local capsules, transient data, and the like.

The system manager nodes 1 and 2, collectively, and CAN1-CAN3 execute a configuration management (CM) process that sets up each node with the appropriate software and configuration data upon initial start-up or after a reboot. Every node in the system also executes a node monitor (NM) process that loads software and tracks processes to determine if any process has failed. System manager nodes 1 and 2 execute a first arbitrary process, P1, and system manager node 1 also executes a second arbitrary process, P2.

In accordance with the principles of the present invention, call application nodes 1-3 (CAN1-CAN3) execute a number of call process (CP) server applications organized as primary and backup processes that are available as distributed group services to 1 to N call process client (CPC) applications, namely CPC APP1-CPC APPn in main processing unit 110. The N call application nodes (e.g., CAN1-CAN3) are separate computing nodes comprising a processor and memory that provide scalability and redundancy by the simple addition of more call application nodes.

Each of the N call process client (CPC) applications, namely CPC APP1-CPC APPn in MPU 110 handles the control signals and messages related to a single call associated with a mobile station. Each of CPC APP1-CPC APPn establishes a session with a mapped resource group, which assigns the call to a particular one of the primary-backup group call process server applications, CP1, CP2, or CP3. The selected call process server application actually performs the call process services/functions requested by the call process client application.

In the illustrated embodiment, three exemplary call process server applications are being executed, namely CP1, CP2, and CP3. Each of these processes exists as a primary-backup group. Thus, CP1 exists as a primary process, CP1p, and a backup process, CP1b. Similarly, CP2 exists as a primary process, CP2p, and a backup process, CP2b, and CP3 exists as a primary process, CP3p, and a backup process, CP3b. In the illustrated embodiment, CP1p and CP1b reside on different call application nodes (i.e., CAN1 and CAN2). This is not a strict requirement: CP1p and CP1b may reside on the same call application node (e.g., CAN1) and still provide reliability and redundancy for software failures of the primary process, CP1p. However, in a preferred embodiment of the present invention, the primary process and the backup process reside on different call application nodes, thereby providing hardware redundancy as well as software redundancy. Thus, CP1p and CP1b reside on CAN1 and CAN2, CP2p and CP2b reside on CAN2 and CAN3, and CP3p and CP3b reside on CAN3 and CAN1.

Together, CP1, CP2 and CP3 form a supergroup for load sharing purposes. Thus, CP1p and CP1b, CP2p and CP2b, and CP3p and CP3b are part of a first mapped resource group (MRG1), indicated by the dotted line boundary. Additionally, CAN1-CAN3 host three other mapped resource groups, namely, MRG2, MRG3, and MRG4. MRG2 comprises two idle list server (ILS) applications, namely ILS1 and ILS2. ILS1 exists as a primary process, ILS1p, on CAN2 and a backup process, ILS1b, on CAN3. ILS2 exists as a primary process, ILS2p, on CAN3 and a backup process, ILS2b, on CAN2. Similarly, MRG3 comprises two identity server (IS) applications, namely IS1 and IS2. IS1 exists as a primary process, IS1p, on CAN1 and a backup process, IS1b, on CAN2 and IS2 exists as a primary process, IS2p, on CAN2 and a backup process, IS2b, on CAN1. Finally, MRG4 comprises two subscriber database (SDB) server applications, namely SDB1 and SDB2. SDB1 exists as a primary process, SDB1p, on CAN2 and a backup process, SDB1b, on CAN3 and SDB2 exists as a primary process, SDB2p, on CAN3 and a backup process, SDB2b, on CAN2.

A group service provides a framework for organizing a group of distributed software objects in a computing network. Each software object provides a service. In addition, the group service framework provides enhanced behavior for determining group membership, deciding what actions to take in the presence of faults, and controlling unicast, multicast, and groupcast communications between members and clients for the group. A group utilizes a policy to enhance the behavior of the services provided by the group. Some of these policies include primary-backup for high service availability and load sharing for distributing the loading of services within a network.

Call process server applications, such as CP1-CP3, ILS1-ILS2, IS1-IS2, and SDB1-SDB2, located within a computing network provide services that are invoked by client applications, such as CPC APP1-CPC APPn. As shown in FIG. 1, the call process server applications are organized into primary-backup groups configured as a 1+1 type of primary-backup group. There are multiple numbers of these primary-backup groups and the exact number is scalable according to the number of processes and/or computing nodes (CANs) that are used. All of the primary-backup groups are themselves a member of a single mapped resource group (e.g., MRG1, MRG2, MRG3, MRG4).

It is important to note that while the call process client applications, CPC APP1-CPC APPn, are clients with respect to the call process server applications, CP1, CP2, and CP3, a server application may be a client with respect to another server application. In particular, the call process server applications CP1-CP3 may be clients with respect to the idle list server applications, ILS1 and ILS2, the subscriber database server applications, SDB1 and SDB2, and the identity server applications, IS1 and IS2.

A client application establishes an interface to the mapped resource group. When a new call indication is received by the client application, the client application establishes a session with the mapped resource group according to a client-side load sharing policy. The initial server (CP1, CP2, etc.) selection policy is CPU utilization-based (i.e., based on the processor load in each of the candidate CANs, with more lightly loaded groups selected first), but other algorithmic policies, such as round-robin (i.e., distribution of new calls in sequential order to each CAN) may be used.

The client application associates the session with the new call and sends messages associated with the call over the session object. The client application also receives messages from the primary-backup group via the session established with the primary-backup group. Only the primary process (e.g., CP1p) of the primary-backup group joins the mapped resource group (e.g., MRG1).

For a variety of reasons, the application containing the primary may be removed from service. With the removal of the primary member, the backup member becomes the primary and the server application is no longer a member of the mapped resource group. However, the client application(s) still maintain their session with the primary-backup group for existing calls. New calls are not distributed to the primary-backup group if it is not a member of the mapped resource group.

If the primary of the primary-backup group (PBG) should fail, the backup member is informed that the primary member has failed (or left) and then assumes the role of primary member. The responsibility for these actions must be performed by the server application. It is the responsibility of the group service to inform the backup member that the primary member has failed or left.

As part of an on-line software upgrade process, one or more applications containing primary-backup groups may be removed from service, brought down, and then brought back up using a new version of software code. These groups, if their interface has not changed, join the existing mapped resource group. When first started, it is required that the client interface be capable of throttling the call traffic to specific primary-backup groups. The traffic throttling is expressed as a percentage varying from 0% (no calls) to 100%. All new calls that would have been scheduled according to the scheduling algorithm are handled by this session. The throttling factor is initialized to 100% for any primary-backup group that joins the mapped resource group. During on-line software upgrades, the throttling factor is adjusted to start with the no-calls case for the new software version. Any client application for the mapped resource group may establish a session with a specific primary-backup group. The client may then change the throttling factor at any time. When the throttling factor is changed, all client session interfaces receive via multicast the changed throttling factor. As the throttling factor is increased, the call process server applications with the new software version may receive increasing amounts of call traffic.

Call processing communications from the client applications to the call processing server primary-backup groups must support a very high volume of calls. The group software utilizes an internal transport consisting of a multicasting protocol (simple IP multicast) and optionally a unicasting protocol. The unicasting protocol may be TCP/IP, SCTP, or other transport protocol. The multicast protocol is used for internal member communications relating to membership, state changes, and fault detection. In the absence of unicast transport, the multicast protocol is used for client/server communication streams. The unicast protocol, when provided, is used to provide a high-speed stream between clients and servers. The stream is always directed to the primary of a primary-backup group, which is transparent to both the call processing client application and the call process (e.g., CP1, CP2, CP3, ILS1, ILS2, IS1, IS2, SDB1, SDB2).

If the primary group member should fail, then the backup group member becomes the new primary member. According to the exemplary embodiment of the present invention, all transient call information during the fail-over period (the time between when the primary fails and the backup is changed to be the new primary) can be lost, but all stable call information is maintained by the backup.

Advantageously, the present invention has no limitations on the scalability of the system and the system size is hidden from both the primary-backup group server applications and call process client applications. The present invention eliminates any single point of failure in the system. Any failure within the system will not affect the system availability and performance.

New call application nodes (CANs) and additional primary-backup group server applications (e.g., CP1, CP2, CP3, ILS1, ILS2, IS1, IS2, SDB1, SDB2) may be added dynamically to the mapped resource groups and can start servicing new call traffic. Call process client applications are not affected by the additions of new servers. If a server should fail, its backup assumes responsibility for the load. This provides high availability for the servicing of each call and minimizes dropped calls.

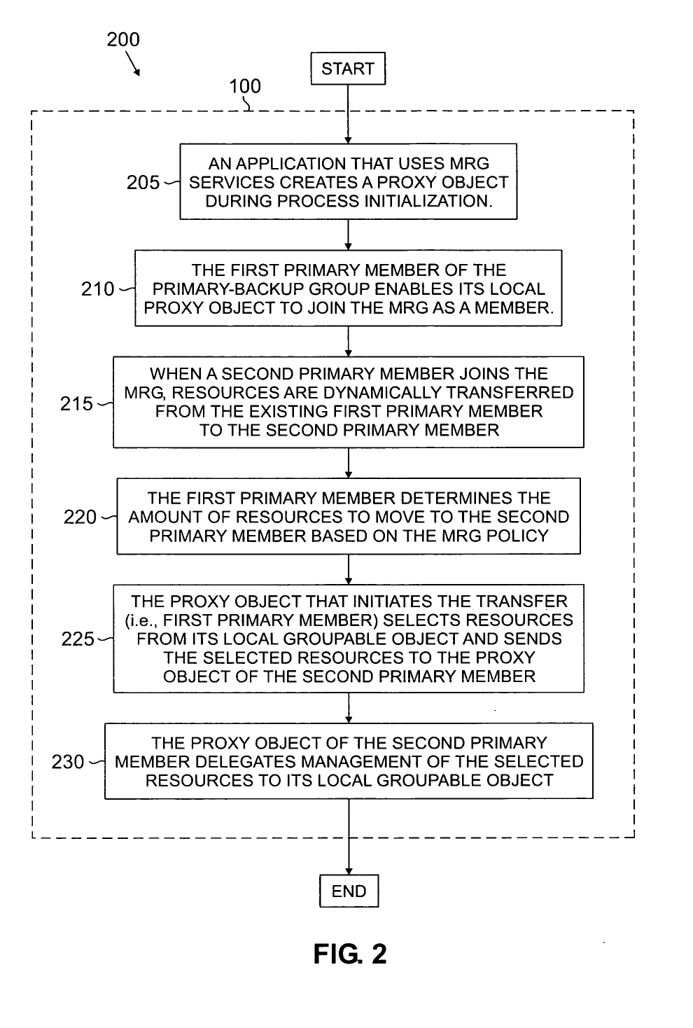

FIG. 2 depicts high-level flow diagram 200, which illustrates the use of proxy objects to manage application resources in mapped resource groups according to the principles of the present invention. Initially, an application that uses the MRG services creates a proxy object during process initialization (process step 205). The first primary member of the primary-backup group enables its local proxy object to join the MRG as a member (process step 210). When a second primary member of a second primary-backup group joins the MRG, resources are dynamically transferred from the existing first primary member to the second primary member (process step 215). The first primary member determines the amount of resources to move to the second primary member based on the MRG policy (process step 220). The proxy object that initiates the transfer (i.e., the first primary member) selects resources from its local groupable object and sends the selected resources to the proxy object of the second primary member (process step 225). The proxy object of the second primary member delegates management of the selected resources to its local groupable object (process step 230).

A mapped resource group (MRG) handles distributed primary-backup groups in which each group manages a specific segment of the total resource and the total resource is mapped in a specific manner. A client application provides a key to the MRG client, which results in the selection of a specific primary-backup group. In the case of a distributed idle list server, MRG2 maps a client idle trunk request to a specific idle list server that manages the idle list.

In FIG. 1, two primary-backup groups (ILS1 and ILS2) are shown in MRG2. This is by way of example only. Other primary-backup groups (e.g., ILS3) may join MRG2, as well. Each primary-backup group has one primary member (e.g., ILS1p) and at least one backup member (e.g., ILS1b). Multiple backups are possible. The primary of each primary-backup group joins the mapped resource group. Each primary is assigned a range of trunk groups to manage and has an allocation list of trunks within each trunk group. MRG2 selects an individual primary-backup group to receive trunk idle list requests. The primary member sends allocation updates to the backup member. If the primary should fail, the backup would take over as the new primary and would continue to provide an allocation service.

MRG2 has a group leader, which is selected at run-time by a leader election algorithm. According to an exemplary embodiment, the first member of MRG2 is elected as the leader and remains the leader until the first member leaves MRG2, either voluntarily or through failure. When the leader leaves or fails, the leader election algorithm is performed and a new leader is elected among all active group members. The responsibilities of the MRG group leader include: 1) retrieving the persistent trunk group data from a network database; 2) partitioning the range of available trunk groups to each MRG member; 3) assigning trunk groups to MRG members according to the number of available MRG members; 4) receiving notifications of updates to the trunk group data from the network database and reassigning trunk groups to MRG members; 5) monitoring MRG membership for additions and removals (either due to voluntary leave or failure) and reassigning trunk groups to MRG members; and 6) monitoring for overload conditions or member-out-of-resource conditions and redistributing the available resources accordingly.

Due to the distributed nature of the idle list server, a client application needs a way to locate a specific server that manages the trunk group in which the client is interested. A Resource Key value is used to map a client request to a specific server that services the resource. Each client policy in each client application is informed dynamically at run-time of which MRG2 members are responsible for each resource. The client policy maintains a dictionary that is keyed by the Resource Key value, which is the equivalent of an ID. The Resource Key value is associated with a specific Client Interface value of a specific primary-backup group that is an MRG2 member. A Resource Range value is used to represent a contiguous range of Resource Key objects (e.g., trunk group ID 1-9). The Resource Range value may be used to efficiently reassign a group of resources to an MRG member.

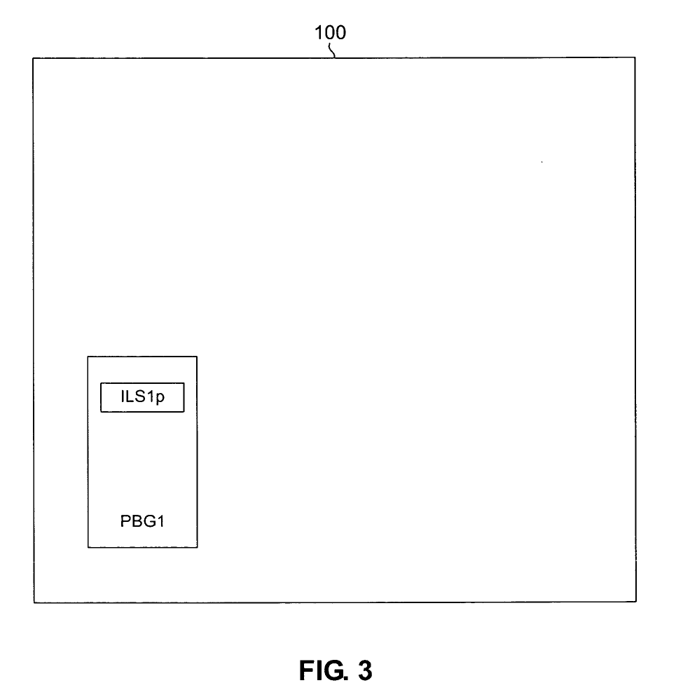

FIGS. 3-6 illustrate selected portions of an idle list server initialization operation according to an exemplary embodiment of the present invention. Initially, an Operations Administration Maintenance and Provisioning (OAM&P) configuration manager (CM) directs a node monitor (NM) to load an idle list server (ILS) capsule from database 120 into a call application node (CAN). As shown in FIG. 3, a primary-backup group (i.e., PBG1) is created and a member object (ILS1p) joins PBG1 group. Since ILS1p is the first member in PBG1, it is designated as the primary member. As PBG1 group is created, it is detected by the CM client in the system manager node (e.g., SYSMGR1). The creation event triggers the staffing of the backup member (ILS1b).

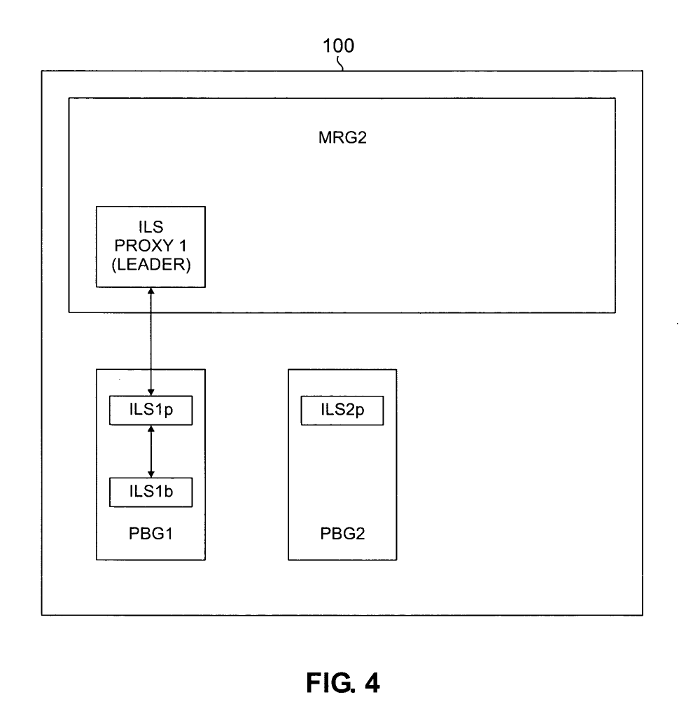

As shown in FIG. 4, upon receiving notification from the MRG2 group service that it is the primary, ILS1p creates an ILS proxy object (i.e., ILS Proxy 1). ILS Proxy 1 creates MRG2 and joins MRG2 as a member. Since ILS Proxy 1 is the first member in MRG2, ILS Proxy 1 is designated as the Leader. The MRG2 Leader retrieves trunk group data from network database 120 and delegates resource management to its local ILS object (ILS1). At this time point, ILS1 (i.e., PBG1) is in control of all trunk groups. The backup member, ILS1b, of PBG1 is loaded and equalized with the primary member.

Next, a second idle list server (ILS) capsule is loaded (in a different CAN). A second primary-backup group (PBG2) is created and a primary member object (ILS2p) joins PBG2 group. Since ILS2p is the first member in PBG2, ILS2p is designated as the primary member. As PBG2 group is created, it is detected by the CM client in SYSMGR1. The creation event triggers the staffing of the second backup member, ILS2b.

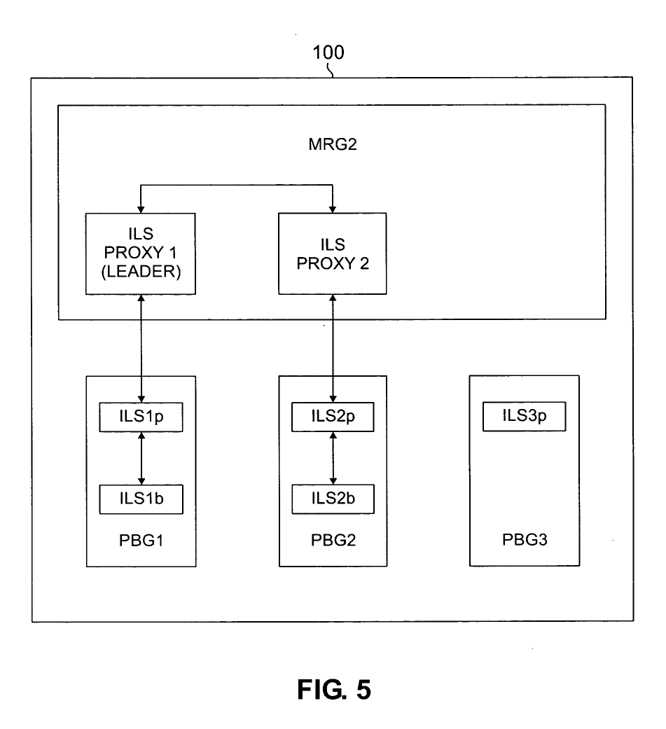

As shown in FIG. 5, upon receiving notification from the group service that it is the primary, ILS2p creates a second ILS proxy object (ILS Proxy 2). ILS Proxy 2 locates MRG2 and joins MRG2 as a member. The MRG Leader (i.e., ILS Proxy 1) detects a new member in the MRG2 group and assigns a subset of the total trunk groups to the new member (i.e., ILS Proxy 2). After receiving the resource allocation, ILS Proxy 2 delegates resource management to its local ILS object (ILS2). At this point, each member of MRG2 will manage about one-half of the total resources. Next, a backup member, ILS2b, of the PBG2 group is loaded and equalized with the primary, ILS2p.

A third idle list server capsule (ILS3) is loaded (in a different CAN). A primary-backup group (PBG3) is created and a member object (ILS3) joins PBG3 group. Since ILS3 is the first member in PBG3, it is designated as the primary member. As the PBG3 group is created, it is detected by the CM client in the system manager node, SYSMGR1. The creation event triggers the staffing of the backup member, ILS3b.

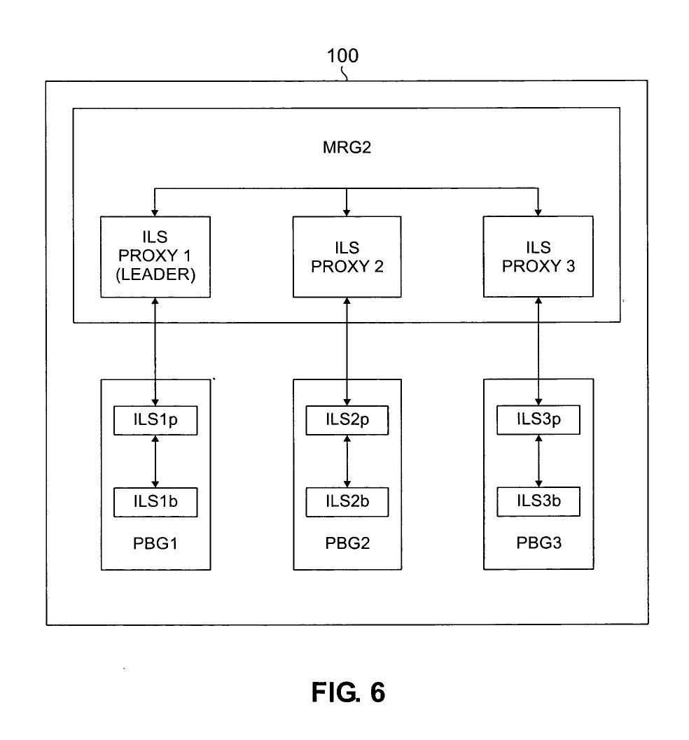

As shown in FIG. 6, upon receiving notification from the group service that it is the primary, ILS3p creates an ILS Proxy object (i.e., ILS Proxy 3). ILS Proxy 3 locates MRG2 and joins MRG2 as a member. The MRG2 Leader (i.e., ILS Proxy 1) detects a new member in the group and instructs group members to assign a subset of the trunk groups to the new member. After receiving the resource allocation, ILS Proxy 3 delegates resource management to its local ILS object (ILS3) . At this point, each MRG2 member manages about one-third of the total resources. Next, the third backup member (ILS3b) of the PBG3 group is loaded and equalized with the primary member, ILS3p. At his point, the initialization is completed.

The foregoing description of the operation of the idle list server (ILS) primary-backup groups is by way of example only and should not be construed so as to limit the scope of the present invention. The identity server (IS) primary-backup groups, the subscriber database (SDB) primary-backup groups, and the call process (CP) primary-backup groups use proxy objects in a similar manner to manage resources in telecommunication device 100.

Although the present invention has been described with an exemplary embodiment, various changes and modifications may be suggested to one skilled in the art. It is intended that the present invention encompass such changes and modifications as fall within the scope of the appended claims.

1. A telecommunication device capable of handling call connections between calling devices and called devices, said telecommunication device comprising:
a main processing unit capable of executing a plurality of client applications, wherein each of said client applications is associated with one of said call connections; and
N call application nodes capable of executing server applications, wherein a first primary server application is executed on a first one of said N call application nodes and wherein said first primary server application comprises a first proxy object that enables said first primary server application to communicate with members of a first mapped resource group, wherein each member of said first mapped resource group provides services in response to requests from ones of said plurality of client applications.

2. The telecommunication device as set forth in claim 1, wherein said first primary server application is associated with a similar second primary server application executed on a second one of said N call application nodes separate from said first call application node, said first and second primary server applications being members of said first mapped resource group.

3. The telecommunication device as set forth in claim 2, wherein said second primary server application comprises a second proxy object that enables said second primary server application to communicate with said first mapped resource group.

4. The telecommunication device as set forth in claim 3, wherein said first primary server application is associated with a similar first backup server application executed on one of said N call application nodes separate from said first call application node, wherein said first primary server application and said first backup server application form a first primary-backup group in which state information associated with said first primary server application is mirrored to said first backup server application.

5. The telecommunication device as set forth in claim 4, wherein said second primary server application is associated with a similar second backup server application executed on one of said N call application nodes separate from said second call application node, wherein said second primary server application and said second backup server application form a second primary-backup group in which state information associated with said second primary server application is mirrored to said second backup server application.

6. The telecommunication device as set forth in claim 5 wherein said each client application sends a call process service request to said first mapped resource group and said first mapped resource group uses a Resource Key to select one of said first and second primary server applications to service said call process service request.

7. The telecommunication device as set forth in claim 6 wherein said first primary server application controls a first group of resources associated with said telecommunication device and said second primary server application controls a second group of resources associated with said telecommunication device.

8. The telecommunication device as set forth in claim 7 wherein said first proxy object is designated as a leader proxy object in said first mapped resource group.

9. The telecommunication device as set forth in claim 8 wherein said first proxy object is capable of reallocating at least one resource from said first group of resources to said second group of resources such that said second primary server application controls at least one reallocated resource.

10. The telecommunication device as set forth in claim 8 wherein said first proxy object is capable of determining that a third primary server application has joined said first mapped resource group and, in response to said detection, is capable of reallocating a first resource from said first group of resources to a third group of resources controlled by said third primary server application and is further capable of reallocating a second resource from said second group of resources to said third group of resources.

11. A communication network comprising a plurality of switching devices, each one of said switching devices capable of handling call connections between calling devices and called devices, said each switching device comprising:
a main processing unit capable of executing a plurality of client applications, wherein each of said client applications is associated with one of said call connections; and
N call application nodes capable of executing server applications, wherein a first primary server application is executed on a first one of said N call application nodes and wherein said first primary server application comprises a first proxy object that enables said first primary server application to communicate with members of a first mapped resource group, wherein each member of said first mapped resource group provides services in response to requests from ones of said plurality of client applications.

12. The communication network as set forth in claim 11, wherein said first primary server application is associated with a similar second primary server application executed on a second one of said N call application nodes separate from said first call application node, said first and second primary server applications being members of said first mapped resource group.

13. The communication network as set forth in claim 12, wherein said second primary server application comprises a second proxy object that enables said second primary server application to communicate with said first mapped resource group.

14. The communication network as set forth in claim 13, wherein said first primary server application is associated with a similar first backup server application executed on one of said N call application nodes separate from said first call application node, wherein said first primary server application and said first backup server application form a first primary-backup group in which state information associated with said first primary server application is mirrored to said first backup server application.

15. The communication network as set forth in claim 14, wherein said second primary server application is associated with a similar second backup server application executed on one of said N call application nodes separate from said second call application node, wherein said second primary server application and said second backup server application form a second primary-backup group in which state information associated with said second primary server application is mirrored to said second backup server application.

16. The communication network as set forth in claim 15 wherein said each client application sends a call process service request to said first mapped resource group and said first mapped resource group uses a Resource Key to select one of said first and second primary server applications to service said call process service request.

17. The communication network as set forth in claim 16 wherein said first primary server application controls a first group of resources associated with said each switching device and said second primary server application controls a second group of resources associated with said each switching device.

18. The communication network as set forth in claim 17 wherein said first proxy object is designated as a leader proxy object in said first mapped resource group.

19. The communication network as set forth in claim 18 wherein said first proxy object is capable of reallocating at least one resource from said first group of resources to said second group of resources such that said second primary server application controls at least one reallocated resource.

20. The communication network as set forth in claim 18 wherein said first proxy object is capable of determining that a third primary server application has joined said first mapped resource group and, in response to said detection, is capable of reallocating a first resource from said first group of resources to a third group of resources controlled by said third primary server application and is further capable of reallocating a second resource from said second group of resources to said third group of resources.

21. A method for use in a telecommunication device comprising 1) a main processing unit for executing client applications; and 2) N call application nodes for executing server applications, the method comprising the steps of:
executing a first primary server application on a first call application node;
executing a second primary server application on a second call application node separate from the first call application node, wherein the first and second primary server applications are members of a first mapped resource group;
using a first proxy object to join the first primary server application to the first mapped resource group, wherein the first proxy object enables the first primary server application to communicate with members of the first mapped resource group; and
using a second proxy object to join the second primary server application to the first mapped resource group, wherein the proxy object enables the first primary server application to communicate with members of the first mapped resource group, and wherein each member of the first mapped resource group provides services in response to requests from the client applications.
